(19) United States
(12) Patent Application Publication
(10) Pub. No.: US 2015/0367389 A1
(43) Pub. Date: Dec. 24, 2015

(54) INTELLIGENT AIR CURTAIN FUME HOOD

(71) Applicants: KingLab Laboratory Equipment Co., Ltd., Taoyuan County (TW); Win-Chiang Stainless Steel Co., Ltd., Taoyuan County (TW); National Taiwan University of science and Technology, Taipei City (TW)

(72) Inventors: Chin-Tsung LEE, New Taipei City (TW); Rong-Fung HUANG, Taipei City (TW)

(21) Appl. No.: 14/506,337

(22) Filed: Oct. 3, 2014

(30) Foreign Application Priority Data
Jun. 20, 2014 (TW) 103121342

(51) Int. Cl. B08B 15/02

(52) U.S. Cl. CPC B08B 15/023

(57) ABSTRACT

The present invention provides an intelligent air curtain fume hood, which includes cabinet, inclined air curtain module, intelligent window control module and processing module. Feature of the present invention is that the inclined air curtain module is the use of inclined air flow field distribution generated during the operation of shelter in the work space, and with variable air volume theory in order to reduce the gas leaking chance to further achieve security and energy saving effect.

### CROSS-REFERENCE TO RELATED APPLICATION

This application claims priority from Taiwan Patent Application No. 103121342, filed on Jun. 20, 2014, in the Taiwan Intellectual Property Office, the content of which are hereby incorporated by reference in their entirety for all purposes.

### BACKGROUND OF THE INVENTION

1. Field of the Invention

The present invention provides an intelligent air curtain fume hood, in particular with respect to an intelligent air curtain fume hood using an inclined air curtain flow filed distribution generated during the operation of shelter in a work space and with variable air volume theory in order to reduce the gas leaking chance to further achieve security and energy saving effect.

2. Description of the Related Art

The traditional fume hood is designed to dispose an air-exhaust device upon a cabinet, and uses the negative pressure attract to guide gas in the work space to ventilation channel to be exhausted; however, the air-exhaust velocity directly affects the gas's exhaust efficiency, and the known exhaust device is unable to effectively exhaust the gas instantly, and operating personnel's health is therefore influenced.

In view of the technical problem, the prior art disclosed using an air-out device and an exhaust device which correspond to each other up and down to form an air curtain flow filed, which not only accelerates the exhaust efficiency, but also forms a shelter for gas flow field to prevent the gas leaking such that affects the operating personnel. Although the preceding technique is able to reduce the gas leaking chance effectively, combining variable air volume (VAV) with window's position to automatically adjust a matched proportion of air-out and air-exhaust velocities to maintain the best air curtain gas flow field has not been further discussed yet.

In actual usage, position of the observation window affects user's operation accuracy, and in case it has to usually adjust the window's position manually in the process of operation, insidiously, it is easy to guide the gas to the external environment so that pollution becomes inevitable, and cross infection is occurred as hand touches the window. Furthermore, it may happen that the user forgets to turn off the related apparatuses when the operation is completed so that it causes unnecessary energy waste.

According to the aforementioned description, the invention of the present invention designs an intelligent air curtain fume hood which aims at improving the current technique so as to increase the industrial applicability.

### SUMMARY OF THE INVENTION

In view of the technical problem of prior art, purpose of the present invention is to provide an intelligent air curtain fume hood which is the use of an inclined air flow field to reduce the gas leaking amount generated during the operation so as to avoid the operating environment from being polluted.

In view of the technical problem of prior art, purpose of the present invention is to provide an intelligent air curtain fume hood which uses the VAV theory to adjust a matched proportion of an air-out velocity of the air-out device and an air-exhaust velocity of the exhaust device so as to effectively reduce energy waste and achieve energy saving effect.

In view of the technical problem of prior art, purpose of the present invention is to provide an intelligent air curtain fume hood which provides the user with an intelligent window control module for manually or automatically adjusting the position of the observation window so as to instantly adjust the operation range of the work space.

In view of the technical problem of prior art, purpose of the present invention is to provide an intelligent air curtain fume hood which cooperates with an environment sensing controlling module to detect usage state of the intelligent air curtain fume hood, and automatically maintains minimum limited operation of the apparatus while the user leaves so as to avoid energy waste.

In view of the technical problem of prior art, purpose of the present invention is to provide an intelligent air curtain fume hood which cooperates with a temperature sensing module and a gas concentration detection module to detect temperature variation as well as content of gas concentration of the work space so as to undertake safety measures to ensure safety of the operator and apparatus.

The present invention is to provide an intelligent air curtain fume hood which may comprise a cabinet, an inclined air curtain module, an intelligent window control module and a processing module. The cabinet may comprise a working platform, an observation window and an exhaust device, the working platform disposed in the cabinet and forming a work space with the observation window for operating.

The inclined air curtain module may provide an air curtain flow field to prevent gas leaking to environment, and the inclined air curtains module may comprise an air-out device and an air weight control device; the air-out device may be disposed on the working platform and adjacent to one side of the observation window, the air-out device and the exhaust device may be spaced a distance, the air-out device may spray air flow upwardly to the exhaust device to form an inclined air flow field and may control a matched proportion of an air-out velocity of the air-out device and an air-exhaust velocity of the exhaust device to form the air curtain flow field by the air weight control device.

The intelligent window control module may comprise a window driving device controlling operation of the observation window, and a window positioning detection device detecting a relative position of the observation window and returning a position signal.

The processing module may be disposed in the cabinet and electrically connected with the cabinet, the inclined air curtain module and the intelligent window control module; the processing module may receive the position signal and adjust air volumes of the exhaust device and the air-out device by a variable air volume theory.

Preferably, the exhaust device may further comprise a guiding flow unit guiding a flow direction of the air curtain flow field.

Preferably, the air-out device may further comprise a fairing unit providing stable air flow.

Preferably, the air-out device may comprise a frequency conversion DC brushless motor, a DC brushless motor, a blower or a turbofan.

Preferably, the matched proportion of air-out velocity of the air-out device and air-exhaust velocity of the exhaust device may be between 1:6 and 1:15.

Preferably, the intelligent window control module may further comprise a positioning correction device instantly correcting control parameter of the intelligent window control module.

Preferably, the intelligent window control module may further comprise a window safety detection device detecting objects within a detection range.

Preferably, the processing module may further comprise an input unit for a user using.

Preferably, the intelligent air curtain fume hood of the present invention may further comprise an environment sensing controlling module detecting usage state of the intelligent air curtain fume hood.

Preferably, the intelligent air curtain fume hood of the present invention may further comprise a temperature sensing module turning on fire extinguishing appliance and related actions to conduct fire-extinguishing occurred in the cabinet under the setting conditions to protect safety of operation personnel and apparatus.

Preferably, the intelligent air curtain fume hood of the present invention may further comprise a gas concentration detection module detecting content of gas concentration of the work space.

Preferably, The primary purpose of the present invention is to provide an intelligent air curtain fume hood which may have one or more following advantages:

1. Safety protection: using an inclined air curtain and VAV theory to adjust a matched proportion of air-out velocity and air-exhaust velocity to maintain the best gas flow field distribution so as to reduce the gas leaking chance to achieve purpose of safety protection.

2. Reducing pollution: it is unnecessary to manually adjust the observation window's position in the process of operation, it can use the intelligent window control module to automatically drive the relative position of the observation window to prevent unnecessary pollution caused by the operation personnel passing through the air curtain back and forth to cause the internal gas leaking to environment, the external gas flowing into the work space, or frequently contacting with the window such that results in cross infection.

Saving energy: as the VAV theory is to adjust the operation speed or air gate of blower based on the practical need so as to achieve to an adequate air-exhaust amount to avoid unnecessary waste of air-condition. Furthermore, it can cooperate with an environment sensing controlling module to determine whether the user leaves the operation range so as to turn off the window and to maintain in a minimum limit, and to cooperate with VAV control to minimize the energy consumption so as to achieve saving energy.

With these and other objects, advantages, and features of the invention that may become hereinafter apparent, the nature of the invention may be more clearly understood by reference to the detailed description of the invention, the embodiments and to the several drawings herein.

### BRIEF DESCRIPTION OF THE DRAWINGS

Hereinafter, embodiments of the present invention will be described in detail with reference to the accompanying drawings so that those skilled in the art to which the present invention pertains can realize the present invention, wherein:

FIG. 1 is a block diagram of an intelligent air curtain fume hood of the resent invention.

FIG. 2 is a schematic diagram of an intelligent air curtain fume hood of the present invention.

FIG. 3 is a schematic diagram of a first embodiment of an intelligent air curtain fume hood of the present invention.

FIG. 4 is a schematic diagram of a second embodiment of an intelligent air curtain fume hood of the present invention.

### DETAILED DESCRIPTION OF THE PREFERRED EMBODIMENTS

Hereinafter, embodiments of the present invention will be described in detail with reference to the accompanying drawings so that those skilled in the art to which the present invention pertains can realize the present invention. As those skilled in the art would realize, the described embodiments may be modified in various different ways, all without departing from the spirit or scope of the present invention.

The exemplary embodiments of the present invention will be understood more fully from the detailed description given below and from the accompanying drawings of various embodiments of the invention, which, however, should not be taken to limit the invention to the specific embodiments, but are for explanation and understanding only.

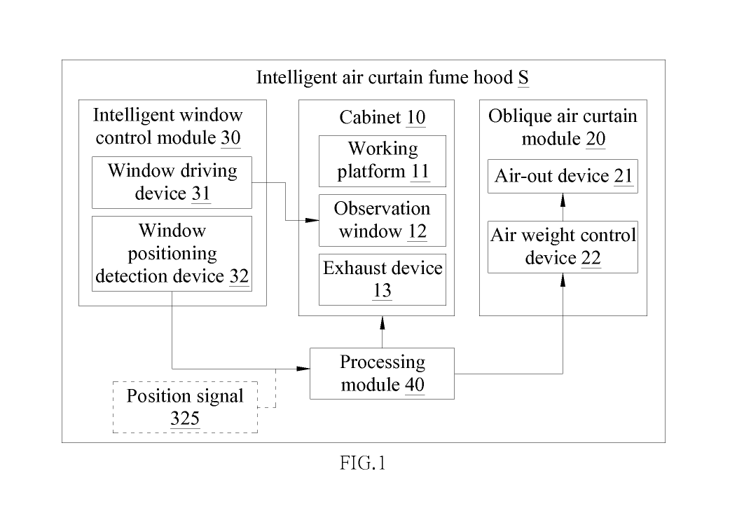

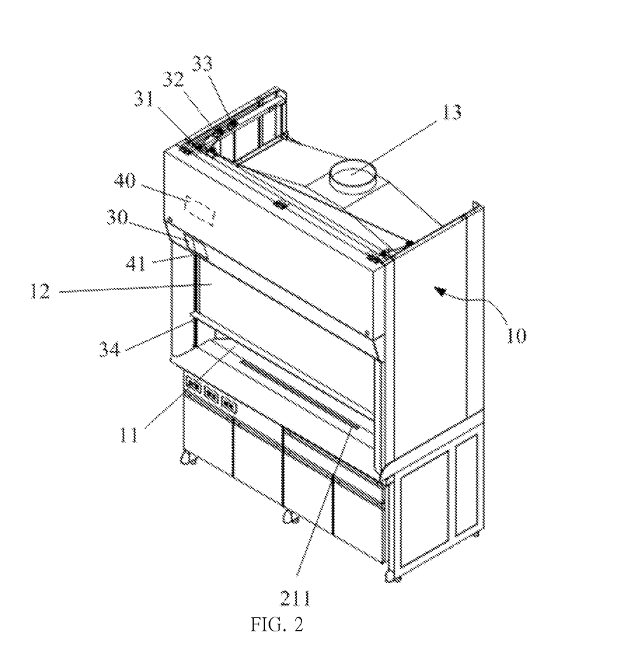

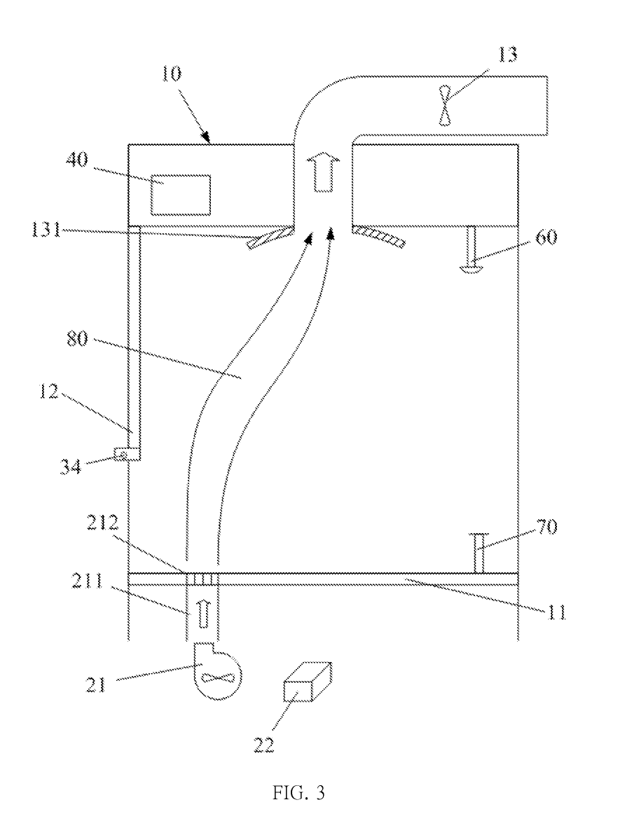

Please refer to FIG. 1 to FIG. 3 simultaneously. FIG. 1 is a block diagram of an intelligent air curtain fume hood of the resent invention, FIG. 2 is a schematic diagram of an intelligent air curtain fume hood of the present invention and FIG. 3 is a schematic diagram of a first embodiment of an intelligent air curtain fume hood of the present invention. It can be seen from the FIGS. that an intelligent air curtain fume hood S comprises a cabinet 10, an inclined air curtain module 20, an intelligent window control module 30 and a processing module 40. The cabinet 10 comprises a working platform 11, an observation window 12 and an exhaust device 13. The working platform 11 is disposed in the cabinet 10 and forms a work space with the observation window 12 for operating. The observation window 12 is a perspective device which provides the direct observation of operation steps, and the observation window 12 comprises frame and observation window, wherein the material of the observation window is made of transparent material based on the practical need. The exhaust device 13 is disposed on the cabinet 10 and attracts the gas from the air-exhaust channel by the negative pressure formed of operation of the blower.

The inclined air curtain module 20 provides an air curtain flow field 80 to prevent gas leaking to environment, and the inclined air curtains module 20 comprises an air-out device 21 and an air weight control device 22; the air-out device 21 is disposed on the working platform 11 and adjacent to one side of the observation window 12, the air-out device 21 and the exhaust device 13 are spaced a distance, air flow of the air-out device 21 is sprayed upwardly along an air-exhaust channel 211, and is attracted by negative pressure of the exhaust device 13 to form an inclined air flow field distribution; in addition, it controls a matched proportion of an air-out velocity of the air-out device 21 and an air-exhaust velocity of the exhaust device 13 to form a stable air curtain flow field 80 by the air weight control device 22 so as to provide an integral gas shelter effect and to avoid the disturbance of gas leaking.

In applicability, the air-out device 21 is further designed to dispose with a fairing unit 212 on the air-exhaust channel 211 and by using the air-exhaust channel 211 to provide stable air flow to prevent turbulent flow disturbing the stability of the whole air curtain flow field 80. The exhaust device 13 is further disposed with the fairing unit 131, and by using structure of the fairing unit 131 to guide flow direction of the air flow, it thereby increases the air-exhaust efficiency. Wherein the air-out device 21 comprises a frequency conversion DC brushless motor, a DC brushless motor, a blower or a turbofan based on practical need, and the present embodiment only takes a frequency conversion DC brushless motor for example. By means of the frequency conversion DC brushless motor, it not only satisfies with the demand of VAV frequency conversion operation, but also prevents sparks generating in the process of operation, so that dangers such as explosion or air blast and so on is thereby avoided.

The intelligent window control module 30 comprises a window driving device 31 and a window positioning detection device 32. The window driving device 31 controls operation of the observation window 12, and the window positioning detection device 32 conducts a linear linking-up with the observation window 12 and returns a position signal 325.

Subsequently, the intelligent window control module 30 further comprises a positioning correction device 33, and when a user 90 adjusts position of the observation window 12, the window positioning detection device 32 sorts out the position signal 325 having related position and accordingly returns it. The positioning correction device 33 determines the relative position of the observation window 12 based on the position signal 325 and instantly corrects the related control parameter of the intelligent window control module 30 to enable the intelligent window control module 30 effectively and instantly controlling the position of the observation window 12 through the window driving device 31.

Furthermore, the intelligent window control module 30 further comprises a window safety detection device 34 detecting objects within a detection range. For example, when the user 90 desires to adjust the position of the observation window 12, it only needs to put the hand in the detection range of the window safety detection device 34 to drive the window driving device 31 adjusting the position of the observation window 12; consequently, it avoids unnecessary pollution caused by the user 90 passing through the air curtain flow field 80 back and forth to cause the internal gas leaking to environment, the external gas flowing into the work space, or frequently contacting with the window such that results in cross infection.

Moreover, when the user 90 is in a desired descent direction which is the observation window 12 to be adjusted to or the observation window 12 automatically descends itself in order to save energy while in unmanned operation, the window safety detection device 34 detects objects within the detection range, and if there are other objects beneath the observation window 12 and affect the action range, action of the observation window 12 stops to prevent damaging goods or other dangers so as to further achieve purpose of safety protection.

The processing module 40 is disposed in the cabinet 10 and electrically connected with the cabinet 10, the inclined air curtain module 20 and the intelligent window control module 30; the processing module 40 further comprises an input unit 41 enabling the user 90 inputting related control parameter, for example inputting the control parameters, such as the top and down extreme position of the observation window 12, the relative distance between the observation window 12 and the user's 90 hand.

When the observation window 12 adjusts the opened range along the user's 90 operation process, the processing module 40 receives the position signal 325 based on the related position of the observation window 12; namely, it uses VAV theory to adequately adjust a matched proportion of the an air-out velocity of the air-out device 21 and an air-exhaust velocity of the exhaust device 13, wherein range of the matched proportion is between 1:6 and 1:15 so that it can maintain the best gas flow field 80 distribution so as to reduce the gas leaking chance to achieve purpose of safety protection.

In applicability, the intelligent air curtain fume hood S further comprises a temperature sensing module 60, and when the temperature variation in the work space exceeds a predetermined value, it turns on the fire extinguishing appliance and the related actions are conducted to put out a fire occurred in the cabinet to protect safety of operation personnel and apparatus.

In addition, the intelligent air curtain fume hood S further comprises a gas concentration detection module 70, and when the gas concentration exceeds a predetermined allowable value, it sends out a warning signal and the air-exhaust efficiency of the exhaust device 13 is increased to lower the gas concentration in the work space.

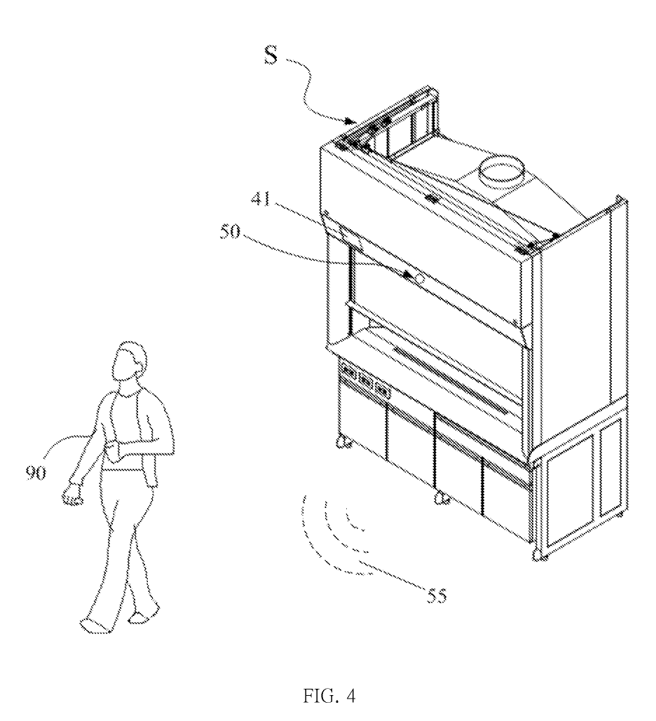

Please refer to FIG. 4 which is a schematic diagram of a second embodiment of an intelligent air curtain fume hood of the present invention. It can be seen from the FIG. that the intelligent air curtain fume hood S further comprises an environment sensing controlling module 50 detecting usage state of the intelligent air curtain fume hood S. When the user 90 is working or leaves and forgets to turn off the related apparatus, the environment sensing controlling module 50 of the intelligent air curtain fume hood S sends a detection signal 55 to detect whether the user 90 is within the detection range and the operation is necessary to keep.

If the user 90 is not detected within a period, the environment sensing controlling module 50 sends the signal to automatically adjust the related apparatuses such as the illuminating device, the exhaust device 13, the air-out device 21 and so on to standby mode and only provides the necessary energy for maintaining limited operation. For example, when in the standby mode, the intelligent window control module 30 descends the observation window 12 to the extreme position, and to cooperate with VAV system to adjust operations of the air-out device 21 and the exhaust device 13 so as to reduce the energy waste.

Furthermore, the intelligent air curtain fume hood S executes shutdown or standby mode based on the setting operation process after a period passing through to effectively promote the energy saving effect.

While the means of specific embodiments in present invention has been described by reference drawings, numerous modifications and variations could be made thereto by those skilled in the art without departing from the scope and spirit of the invention set forth in the claims. The modifications and variations should in a range limited by the specification of the present invention.

What is claimed is:

1. An intelligent air curtain fume hood, comprising:
a cabinet comprising a working platform, an observation window and an exhaust device;
the working platform disposed in the cabinet and forming a work space with the observation window for operating;
an inclined air curtain module providing an air curtain flow field to prevent gas leaking to environment, the inclined air curtains module comprising an air-out device and an air weight control device; the air-out device disposed on the working platform and adjacent to one side of the observation window, the air-out device and the exhaust device spaced a distance, the air-out device spraying air flow upwardly to the exhaust device to form an inclined air flow field and controlling a matched proportion of an air-out amount of the air-out device and an air-exhaust amount of the exhaust device to form the air curtain flow field by the air weight control device;
an intelligent window control module comprising a window driving device controlling operation of the observation window, and a window positioning detection device detecting a relative position of the observation window and returning a position signal; and
a processing module disposed in the cabinet and electrically connected with the cabinet, the inclined air curtain module and the intelligent window control module; the processing module receiving the position signal and adjusting air volumes of the exhaust device and the air-out device by a variable air volume theory.

2. The intelligent air curtain fume hood of claim 1, wherein the exhaust device further comprises a guiding flow unit guiding a flow direction of the air curtain flow field.

3. The intelligent air curtain fume hood of claim 1, wherein the air-out device further comprises a fairing unit providing stable air flow.

4. The intelligent air curtain fume hood of claim 1, wherein the air-out device comprises a frequency conversion DC brushless motor, a DC brushless motor, a blower or a turbofan.

5. The intelligent air curtain fume hood of claim 1, wherein the matched proportion of air-out velocity of the air-out device and air-exhaust velocity of the exhaust device is between 1:6 and 1:15.

6. The intelligent air curtain fume hood of claim 1, wherein the intelligent window control module further comprises a positioning correction device instantly correcting control parameter of the intelligent window control module.

7. The intelligent air curtain fume hood of claim 1, wherein the intelligent window control module further comprises a window safety detection device detecting objects within a detection range.

8. The intelligent air curtain fume hood of claim 1, wherein the processing module further comprises an input unit for a user using.

9. The intelligent air curtain fume hood of claim 1, further comprising an environment sensing controlling module detecting usage state of the intelligent air curtain fume hood.

10. The intelligent air curtain fume hood of claim 1, further comprising a temperature sensing module detecting temperature variation of the work space.

11. The intelligent air curtain fume hood of claim 1, further comprising a gas concentration detection module detecting content of gas concentration of the work space.
